(19) United States
(12) Patent Application Publication
(10) Pub. No.: US 2014/0068788 A1
(43) Pub. Date: Mar. 6, 2014

(54) INFORMATION PROCESSING APPARATUS, INFORMATION PROCESSING SYSTEM, INFORMATION PROCESSING METHOD, PROGRAM AND CLIENT TERMINAL

(71) Applicant: Sony Corporation, Minato-ku (JP)

(72) Inventors: Yu TANAKA, Tokyo (JP); Yohei Kawamoto, Tokyo (JP); Kazuya Kamio, Tokyo (JP); Masanobu Katagi, Kanagawa (JP); Harunaga Hiwatari, Kanagawa (JP)

(73) Assignee: Sony Corporation, Minato-ku (JP)

(21) Appl. No.: 13/960,342

(22) Filed: Aug. 6, 2013

(30) Foreign Application Priority Data
Sep. 4, 2012 (JP) 2012-193891

(51) Int. Cl. G06F 21/31

(52) U.S. Cl. CPC G06F 21/31
USPC 726/28

(57) ABSTRACT

There is provided an information processing apparatus including a processing request acquisition unit configured to sequentially acquire a plurality of processing requests from a user, and an authentication execution unit configured to distribute and execute user authentication processing according to a timing of acquiring the plurality of processing requests.

### BACKGROUND

The present disclosure relates to an information processing apparatus, an information processing system, an information processing method, a program and a client terminal.

In the related art, for example, following Japanese Patent Laid-Open No. 2010-67004 discloses a technique of acquiring the number of users at the current time when an authentication server authenticates login users and replying the login wait time to terminals when the capacity is exceeded, in order to adequately reduce the load at the time of log in.

Also, following Japanese Patent Laid-Open No. 2002-278930 discloses a technique of transmitting a desired webpage to a terminal used by the user authenticated once without authentication since the load due to an input requested for the authentication increases as the number of URL's which the user wants to access increases.

### SUMMARY

However, the technique disclosed in Japanese Patent Laid-Open No. 2010-67004 is a technique that aims to reduce the load on a server, and a harmful effect of causing the wait time occurs in a case where there are a lot of users. Therefore, in a case where there are a lot of users, it is not possible to increase the login speed (i.e. user authentication speed) without causing the wait time.

Also, the technique disclosed in Japanese Patent Laid-Open No. 2002-278930 is a technique of omitting a following password input and not performing authentication for the user authenticated once. Therefore, although it is possible to save the effort of authentication, it is assumed that a stranger pretends to be a real user and logs in because of no authentication, and there is a problem in respect of the security.

Therefore, it is requested to reduce the load at the time of user authentication and secure the security against spoofing or the like.

According to an embodiment of the present disclosure, there is provided an information processing apparatus including a processing request acquisition unit configured to sequentially acquire a plurality of processing requests from a user, and an authentication execution unit configured to distribute and execute user authentication processing according to a timing of acquiring the plurality of processing requests.

Further, the authentication execution unit may set a number of times of the user authentication processing according to an authentication level of each of the plurality of processing requests and execute the user authentication processing.

Further, the authentication execution unit may execute the user authentication processing using an authentication protocol that repeats an exchange of information for the user authentication processing a plurality of times.

Further, the authentication execution unit may execute user authentication processing by an MQ protocol.

Further, the information processing apparatus may further include an authentication count record unit configured to record a repeat count n of the user authentication processing executed. The authentication execution unit may further execute the user authentication processing in a case where the repeat count n does not reach a repeat count n′ set in advance depending on a type of the processing request.

Further, the authentication execution unit may execute the user authentication processing until the repeat count n reaches the repeat count n′ set in advance depending on the type of the processing request.

Further, the authentication execution unit may further execute the user authentication processing (n′−n) times in a case where the repeat count n does not reach the repeat count n′ set in advance depending on the type of the processing request.

Further, the repeat count n′ set in advance may be set to be a higher value as confidentiality of a processing request of a user is higher.

Further, the repeat count n′ set in advance may be set to be a different value for each user.

Further, the authentication execution unit may reset the repeat count n of the user authentication processing executed to 0 in a case where the user authentication processing is not normally executed.

Further, according to an embodiment of the present disclosure, there is provided an information processing system including a client terminal configured to transmit a processing request input from a user, and a server including a processing request acquisition unit configured to sequentially acquire a plurality of the processing requests from the client terminal, and an authentication execution unit configured to distribute and execute user authentication processing according to a timing of acquiring the plurality of the processing requests.

Further, according to an embodiment of the present disclosure, there is provided an information processing method including sequentially acquiring a plurality of processing requests from a user, and distributing and executing user authentication processing according to a timing of acquiring the plurality of processing requests.

Further, according to an embodiment of the present disclosure, there is provided a program that causes a computer to function as a device configured to sequentially acquire a plurality of processing requests from a user, and a device configured to distribute and execute user authentication processing according to a timing of acquiring the plurality of processing requests.

Further, according to an embodiment of the present disclosure, there is provided a client terminal including a transmission unit configured to transmit a processing request input from a user, and a reception unit configured to receive a result of user authentication processing from a server that sequentially acquires a plurality of the processing requests from the client terminal and distributes and executes the user authentication processing according to a timing of acquiring the plurality of the processing requests.

According to the present disclosure, it is possible to reduce the load at the time of user authentication and further secure the security to spoofing or the like.

### BRIEF DESCRIPTION OF THE DRAWINGS

FIG. 1 is an explanatory diagram to explain an outline of an algorithm in a public key authentication scheme;

FIG. 2 is an explanatory diagram to explain an n-pass public key authentication scheme;

FIG. 3 is an explanatory diagram to explain a construction of a specific algorithm according to a 3-pass scheme;

FIG. 4 is a schematic diagram to explain a method of parallelizing the algorithm of the 3-pass scheme illustrated in FIG. 3;

FIG. 5 is a schematic diagram to explain a method of parallelizing the algorithm of the 3-pass scheme illustrated in FIG. 3;

FIG. 6 is an explanatory diagram to explain a construction of a specific algorithm according to a 5-pass scheme;

FIG. 7 is a schematic diagram to explain load distribution by hierarchization of authentication levels according to an embodiment of the present technology;

FIG. 8 is a schematic diagram illustrating a system configuration example according to an embodiment of the present technology;

FIG. 9 is a flowchart indicating processing in a server;

FIG. 10 is a flowchart indicating processing when a session is blocked by a request from a client terminal; and

FIG. 11 is a schematic diagram indicating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### [Regarding Flow of Explanation]

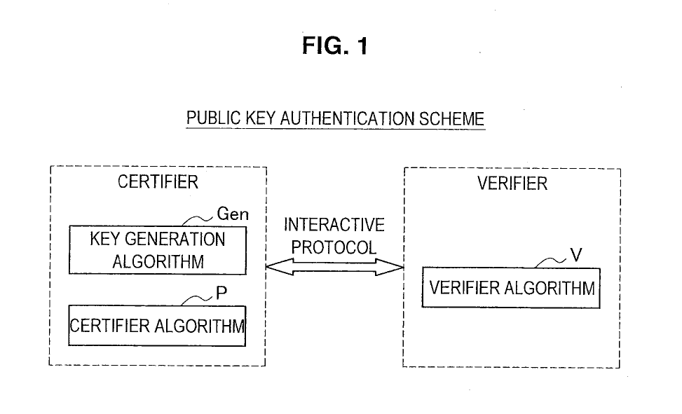

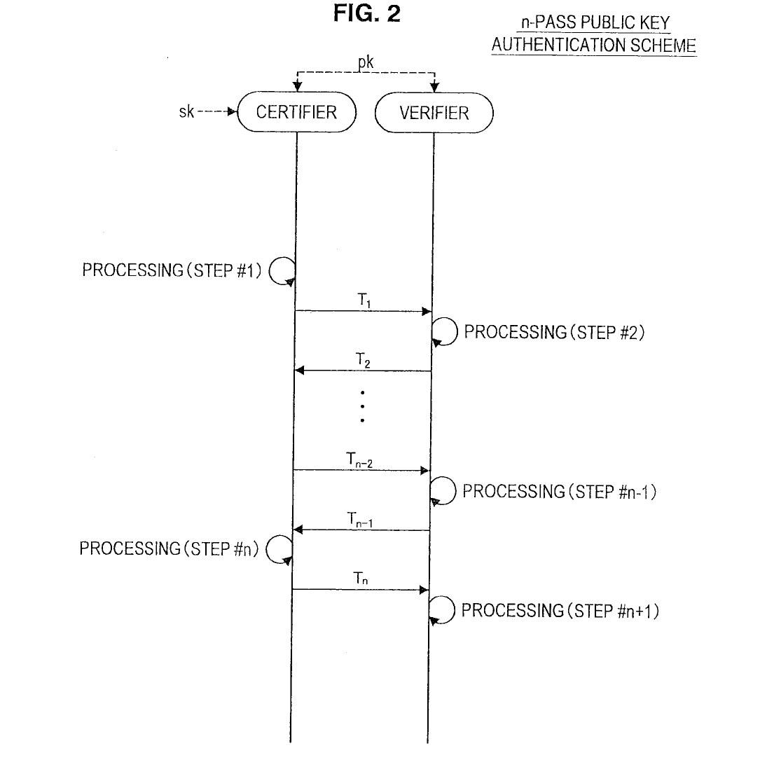

Here, a flow of explanation related to the following embodiment of the present disclosure is described. First, with reference to FIG. 1, an algorithmic construction of a public key authentication scheme is explained. Next, with reference to FIG. 2, an n-pass public key authentication scheme is explained.

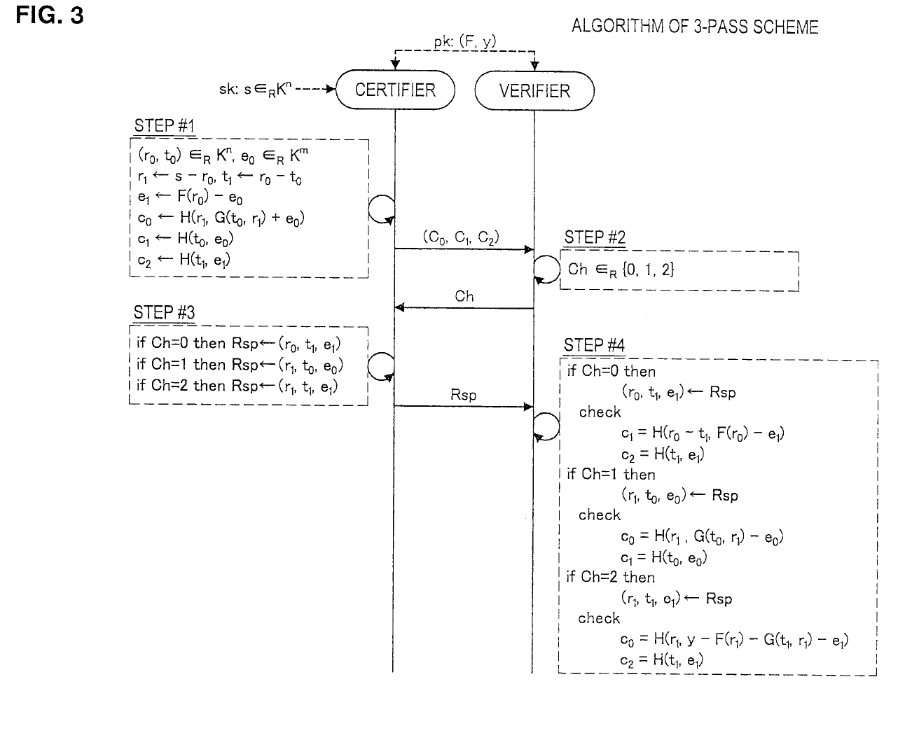

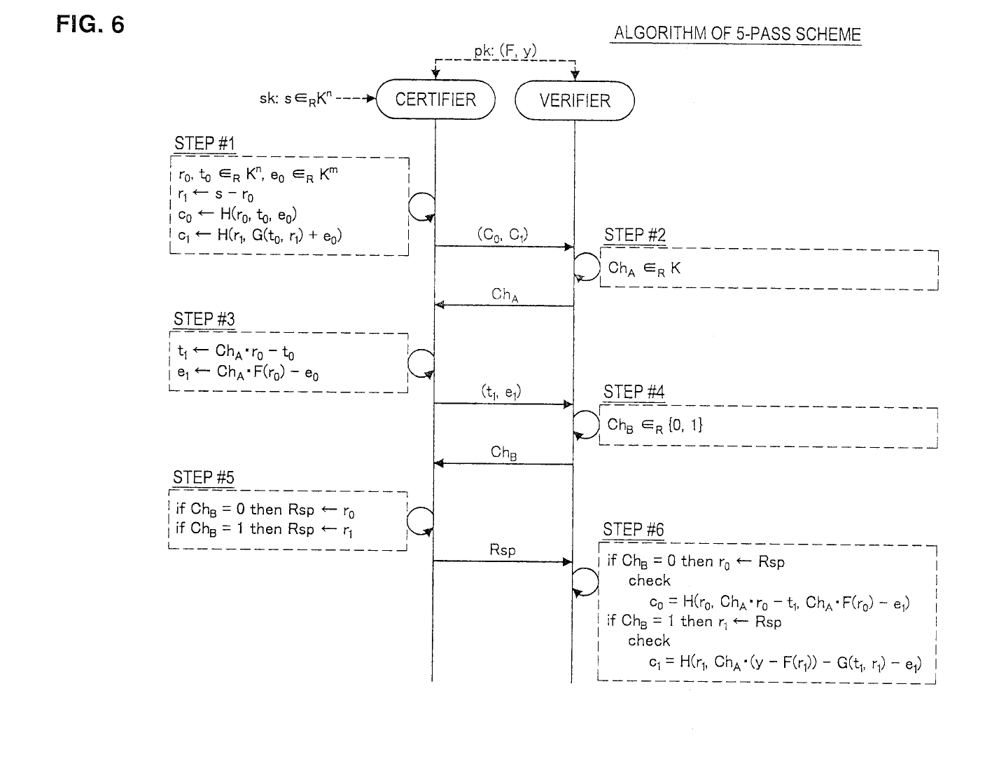

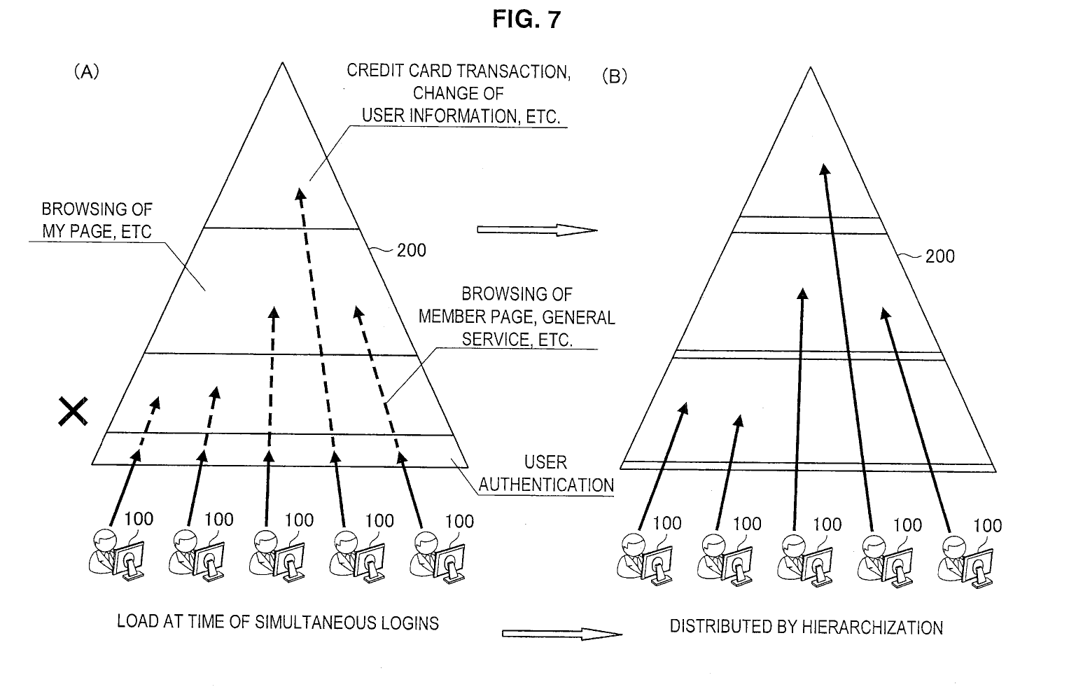

Next, with reference to FIG. 3 to FIG. 5, a construction example of an algorithm according to a 3-pass public key authentication scheme is explained. Next, with reference to FIG. 6, a construction example of an algorithm according to a 5-pass public key authentication scheme is described. Next, with reference to FIG. 7 to FIG. 10, load distribution by hierarchization of authentication levels using a public key authentication scheme is explained.

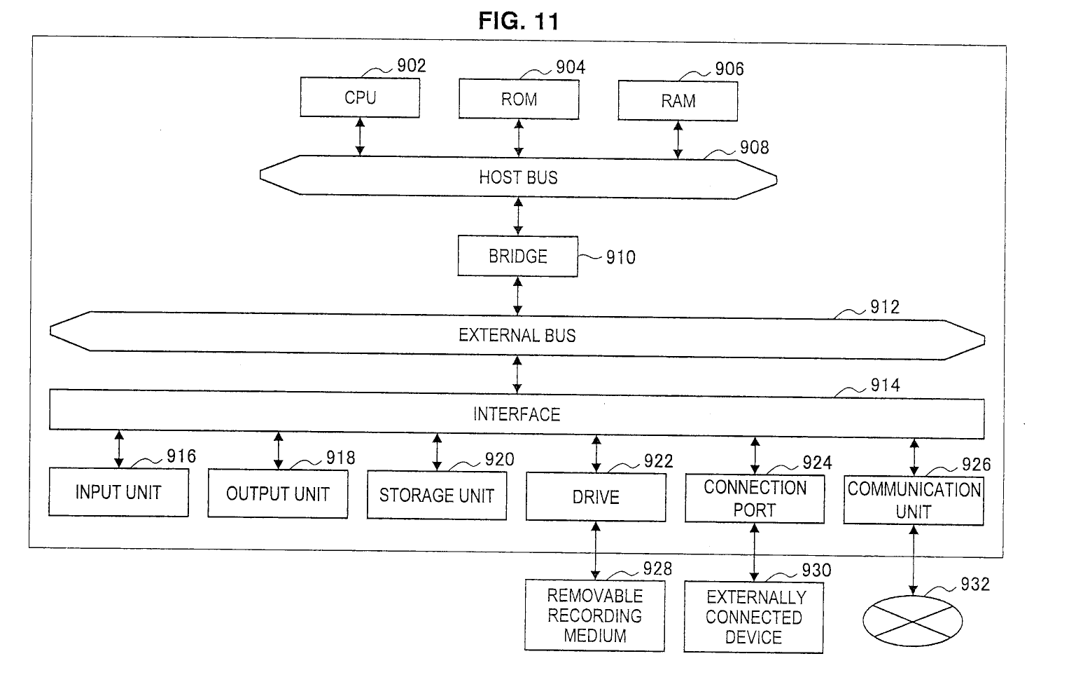

Next, with reference to FIG. 11, a hardware configuration example of an information processing apparatus that can realize each algorithm according to an embodiment of the present disclosure is explained.

Also, the explanation is given in the following order.

1: Introduction

1-1: Algorithm of public key authentication scheme

1-2: N-pass public key authentication scheme

2: Construction of algorithm according to 3-pass public key authentication scheme

2-1: Construction example of specific algorithm

2-2: Construction example of serialization algorithm

3: Construction of algorithm according to 5-pass public key authentication scheme

3-1: Construction example of specific algorithm

4: Example of system configuration

4-1: Outline of system according to the present embodiment

4-2: Configuration example of system

4-3: Operation of system

4-4: Regarding user authentication protocol

4-5: Regarding authentication repeat count n′

4-6: Regarding example to change authentication level every user

5: Configuration example of hardware

### 1: INTRODUCTION

The present embodiment relates to user authentication when the user logs in a client terminal. First, as a suitable user authentication scheme to apply to the present embodiment originally, a public key authentication scheme (which may be hereafter referred to as “MQ protocol”) that puts grounds of security on the hardness of solving problems with respect to multidimensional multivariable simultaneous equations is explained. However, unlike the related art such as an HFE electronic signature scheme, the present embodiment relates to a public key authentication scheme using multidimensional multivariable simultaneous equations without a method (trapdoor) for efficient solution. Also, as described later, an authentication scheme applicable to the present embodiment is not limited to this. First, the outline is easily explained with respect to an algorithm of a public key authentication scheme and an n-pass public key authentication scheme.

### [1-1: Algorithm of Public Key Authentication Scheme]

First, with reference to FIG. 1, an outline of an algorithm of a public key authentication scheme is explained. FIG. 1 is an explanatory diagram to explain an outline of the algorithm of the public key authentication scheme.

The public key authentication is used by a certain person (i.e., certifier) to convince other persons (e.g., verifier) of the identical person by public key pk and secret key sk. For example, public key pk_{A} of certifier A is published to verifier B. Meanwhile, secret key sk_{A} of certifier A is secretly managed by certifier A. In the mechanism of the public key authentication, a person who knows secret key sk_{A} corresponding to public key pk_{A} is regarded as certifier A.

To use the mechanism of the public key authentication and certify to verifier B that certifier A is identified as certifier A, it may be requested to present evidence that certifier A knows secret key sk_{A} corresponding to public key pk_{A}, to verifier B through the conversation protocol. Subsequently, in a case where the evidence that certifier A knows secret key sk_{A} is presented to verifier B and verifier B has confirmed the evidence, the validity of certifier A (i.e., identical person) is certified.

However, to assure the security, the mechanism of the public key authentication is requested to meet the following conditions.

The first condition is that “the probability of perjury establishment by a perjurer who does not have secret key sk when a conversation protocol is executed is recued as much as possible.” Establishment of this first condition is referred to as “soundness.” That is, the soundness is paraphrased with “the perjury is not established by the perjurer who does not have secret key sk at a measurable probability while the conversation protocol is being executed.” The second condition is that “all information on secret key sk_{A} held by certifier A does not leak to verifier B even if the conversation protocol is executed.” Establishment of this second condition is referred to as “zero knowledge.”

To safely perform public key authentication, it is requested to use a conversation protocol having the soundness and the zero knowledge. If authentication processing is performed using a conversation protocol without the soundness and the zero knowledge, since it is not possible to deny the possibility of perjury and the possibility of a leakage of information on a secret key, it does not follow that the validity of the certifier is not certified even if the processing itself is successfully completed. Therefore, it is significant how the soundness and zero knowledge of the conversation protocol are secured.

### (Model)

As illustrated in FIG. 1, a model of a public key authentication scheme includes two entities of a certifier and a verifier. The certifier generates a combination of peculiar secret key sk and public key pk unique to the certifier, using key generation algorithm Gen. Next, the certifier executes a conversation protocol with the verifier through the user of the combination of secret key sk and public key pk generated using key generation algorithm Gen. At this time, the certifier executes the conversation protocol through the use of certifier algorithm P. As described above, using certifier algorithm P, the certifier presents evidence that the certifier owns secret key sk in the conversation protocol, to the verifier.

Meanwhile, the verifier executes the conversation protocol using verifier algorithm V, and verifies whether the certifier owns the secret key supporting a public key published by the certifier. That is, the verifier is an entity to verify whether the certifier owns the secret key supporting the public key. Thus, the model of the public key authentication scheme includes two entities of the certifier and the verifier, and three algorithms of key generation algorithm Gen, certifier algorithm P and verifier algorithms V.

Also, in the following explanation, although expressions of “certifier” and “verifier” are used, these expressions absolutely denote entities. Therefore, the subject that executes key generation algorithm Gen and certifier algorithm P is an information processing apparatus corresponding to the entity of “certifier.” Similarly, the subject that executes verifier algorithm V is an information processing apparatus. The hardware configurations of these information processing apparatuses are as illustrated in FIG. 11, for example. That is, key generation algorithm Gen, certifier algorithm P and verifier algorithm V are executed by a CPU 902 or the like based on a program recorded in a ROM 904, a RAM 906, a storage unit 920 and a removable recording medium 928, and so on.

### (Key Generation Algorithm Gen)

Key generation algorithm Gen is used by the certifier. Key generation algorithm Gen is an algorithm to generate a combination of secret key sk and public key pk to the certifier. Public key pk generated by key generation algorithm Gen is published. Subsequently, published public key pk is used by the verifier. Meanwhile, the certifier secretly manages secret key sk generated by key generation algorithm Gen. Subsequently, secret key sk secretly managed by the certifier is used to certify to the verifier that the certifier owns secret key sk supporting public key pk. Formally, key generation algorithm Gen receives an input of security parameter 1^{λ} (where λ is an integer equal to or greater than 0) and is expressed as Expression (1) listed below, as an algorithm to output secret key sk and public key pk.

(sk,pk)←Gen(1^{λ}) (1)

### (Certifier Algorithm P)

Certifier algorithm P is used by the certifier. Certifier algorithm P is an algorithm to certify to the verifier that the certifier owns secret key sk supporting public key pk. That is, certifier algorithm P is an algorithm to receive an input of secret key sk and public key pk and execute a conversation protocol.

### (Verifier Algorithm V)

Verifier algorithm V is used by the verifier. Verifier algorithm V is an algorithm to verify whether the certifier owns secret key sk supporting public key pk in a conversation protocol. Verifier algorithm V is an algorithm to receive an input of public key pk and output 0 or 1 (1 bit) according to an execution result of the conversation protocol. Also, the verifier determines that the certifier is unauthorized in a case where verifier algorithm V outputs 0, and determines that the certifier is authorized in a case where verifier algorithm V outputs 1. Formally, verifier algorithm V is expressed as Expression (2) listed below.

0/1←V(pk) (2)

As described above, to realize significant public key authentication, the conversation protocol is requested to satisfy two conditions of the soundness and the zero knowledge. However, to certify that the certifier owns secret key sk, the verifier is requested to perform procedures depending on secret key sk, report the result to the verifier and then cause the verifier to perform verification based on the report content. To perform the procedures depending on secret key sk is requested to assure the soundness. Meanwhile, it is requested not to leak all information on secret key sk to the verifier. Therefore, it is requested to cleverly design the above-mentioned key generation algorithm Gen, certifier algorithm P and verifier algorithm V so as to satisfy these requirements.

The outline of the algorithm of the public key authentication scheme has been described above.

### [1-2: N-Pass Public Key Authentication Scheme]

Next, with reference to FIG. 2, the n-pass public key authentication scheme is explained. FIG. 2 is an explanatory diagram to explain the n-pass public key authentication scheme.

As described above, the public key authentication scheme is an authentication scheme to certify to the verifier that the certifier owns secret key sk supporting public key pk in the conversation protocol. Also, the conversation protocol is requested to satisfy two conditions of the soundness and the zero knowledge. Therefore, in the conversation protocol, as illustrated in FIG. 2, information exchange is performed n times while both the certifier and the verifier perform processing.

In the case of an n-pass public key authentication scheme, processing (step #1) is performed by the certifier using certifier algorithm P and information T₁ is transmitted to the verifier. Next, processing (step #2) is performed by the verifier using verifier algorithm V and information T₂ is transmitted to the certifier. Further, execution of processing and transmission of information Tₖ are sequentially performed with respect to k=3 to-n, and processing (step #n+1) is performed at the end. Thus, a scheme to transmit and receive information n times is referred to as the “n-pass” public key authentication scheme.

The n-pass public key authentication scheme has been described above.

### 2: CONSTRUCTION OF ALGORITHM ACCORDING TO 3-PASS PUBLIC KEY AUTHENTICATION SCHEME

In the following, an algorithm according to the 3-pass public key authentication scheme is explained. Also, in the following explanations, the 3-pass public key authentication scheme may be referred to as “3-pass scheme.”

### 2-1: Construction Example of Specific Algorithm (FIG. 3)

First, with reference to FIG. 3, a construction example of a specific algorithm according to the 3-pass scheme is introduced. FIG. 3 is an explanatory diagram to explain a construction of the specific algorithm according to the 3-pass scheme. Here, a case is considered where a combination of quadratic polynomials (f₁(x), . . . , fₘ(x)) is used as part of public key pk. However, it is assumed that quadratic polynomial fi(x) is expressed as Expression (6) listed below. Also, vectors (x₁, . . . , xn) are written as “x” and a combination of quadratic polynomials (f₁(x), . . . , fₘ(x)) is written as “multivariable polynomial F(x)”.

$${f}_{i} ( {x}_{i} , … , {x}_{n} ) = {\sum }_{j , k}^{ } {a}_{ijk} {x}_{j} {x}_{k} + {\sum }_{j}^{ } {b}_{ij} {x}_{j} \qquad ( 6 )$$

Also, a combination of quadratic polynomials (f₁(x), . . . , fₘ(x)) can be express as Expression (7) listed below. Also, A₁, . . . , Aₘ are an n×n matrix. Further, b₁, . . . , bₘ are n×1 vectors respectively.

$$F ( x ) = ( \begin{matrix}{f}_{1} ( x ) \\ ⋮ \\ {f}_{m} ( x )\end{matrix} ) = ( \begin{matrix}{x}^{T} {A}_{1} x + {b}_{1}^{T} x \\ ⋮ \\ {x}^{T} {A}_{m} x + {b}_{m}^{T} x\end{matrix} ) \qquad ( 7 )$$

When this expression is used, multivariable polynomial F can be expressed as Expression (8) and Expression (9) listed below. Establishment of this expression can be easily confirmed from Expression (10) listed below.

$$\begin{matrix}F ( x + y ) = F ( x ) + F ( y ) + G ( x , y ) & ( 8 ) \\ G ( x , y ) = ( \begin{matrix}{y}^{T} ( {A}_{1}^{T} + {A}_{1} ) x \\ ⋮ \\ {y}^{T} ( {A}_{m}^{T} + {A}_{m} ) x\end{matrix} ) & ( 9 ) \\ \begin{matrix}{f}_{l} ( x + y ) = {( x + y )}^{T} {A}_{l} ( x + y ) + {b}_{l}^{T} ( x + y ) \\ = {x}^{T} {A}_{l} x + {x}^{T} {A}_{l} y + {y}^{T} {A}_{l} x + {y}^{T} {A}_{l} y + {b}_{l}^{T} x + {b}_{l}^{T} y \\ = {f}_{l} ( x ) + {f}_{l} ( y ) + {x}^{T} {A}_{l} y + {y}^{T} {A}_{l} x \\ = {f}_{l} ( x ) + {f}_{l} ( y ) + {{x}^{T} ( {A}_{l}^{T} )}^{T} y + {y}^{T} {A}_{l} x \\ = {f}_{l} ( x ) + {f}_{l} ( y ) + {( {A}_{l}^{T} x )}^{T} y + {y}^{T} {A}_{l} x \\ = {f}_{l} ( x ) + {f}_{l} ( y ) + {y}^{T} ( {A}_{l}^{T} x ) + {y}^{T} {A}_{l} x \\ = {f}_{l} ( x ) + {f}_{l} ( y ) + {y}^{T} ( {A}_{l}^{T} + {A}_{l} ) x\end{matrix} & ( 10 )\end{matrix}$$

Thus, when F(x+y) is divided into the first part depending on x, the second part depending on y and the third part depending on both x and y, member G(x,y) corresponding to the third part becomes bilinear with respect to x and y. In the following, member G(x,y) may be referred to as “bilinear member.” When this character is used, it is possible to construct an efficient algorithm.

For example, using vectors t₀εKⁿ and e₀εK^{m}, multivariable polynomial F₁(x) used for the mask of multivariable polynomial F(x+r) is expressed as F₁(x)=G(x,t₀)+e₀. In this case, the sum of multivariable polynomials F(x+r₀) and F₁ (x) is expressed as Expression (11) listed below. Here, when t₁=r₀+t₀ and e₁=F(r₀)+e₀ are set, multivariable polynomial F₂(x)=F(x+r₀)+F₁(x) can be expressed by vectors t₁εKⁿ and e₁εK^{m}. Therefore, when F₁(x)=G(x,t₀)+e₀ is set, it is possible to express F₁ and F₂ by the use of the vector on Kⁿ and the vector on K^{m}, and it is possible to realize an efficient algorithm in which a data size requested for communication is small.

$$\begin{matrix}F ( x + {r}_{0} ) + {F}_{1} ( x ) = F ( x ) + F ( {r}_{0} ) + G ( x , {r}_{0} ) + G ( x , {t}_{0} ) + {e}_{0} \\ = F ( x ) + G ( x , {r}_{0} + {t}_{0} ) + F ( {r}_{0} ) + {e}_{0}\end{matrix} \qquad ( 11 )$$

Here, all information on r₀ is not leaked from F₂ (or F₁). For example, even if e₁ and t₁ (or e₀ and t₀) are given, it is not possible to know all information on r₀ as long as e₀ and t₀ (or e₁ and t₁) are not known. Therefore, the zero knowledge is assured. In the following, the 3-pass scheme algorithm constructed based on the above-mentioned logic is explained. The algorithm of the 3-pass scheme explained herein includes key generation algorithm Gen, certifier algorithm P and verifier algorithm V as listed below.

### (Key Generation Algorithm Gen)

Key generation algorithm Gen generates m items of multivariable polynomials f₁(x₁, . . . , xₙ), . . . , Fₘ(x₁, . . . , xₙ) defined on ring K, and vector s=(s₁, . . . , sₙ) εKⁿ. Next, key generation algorithm Gen calculates y=(y₁, . . . , yₘ)←(f₁(s), . . . , fₘ(s)). Subsequently, key generation algorithm Gen sets (f₁(x₁, . . . , xₙ), . . . , fₘ(x₁, . . . , xₙ),y) as public key pk and sets s as a secret key.

### (Certifier Algorithm P and Verifier Algorithm V)

In the following, with reference to FIG. 3, processing performed by certifier algorithm P and processing performed by verifier algorithm V in the conversation protocol are explained. In this conversation protocol, the certifier certifies to the verifier that “the certifier knows s satisfying y=F(s),” without leaking all information on secret key s to the verifier. Meanwhile, the verifier verifies whether the certifier knows “s” satisfying y=F(s). Here, it is assumed that public key pk is published to the verifier. Also, it is assumed that secret key s is secretly managed by the certifier. In the following, an explanation is given along the flowchart illustrated in FIG. 3.

### Step #1:

As illustrated in FIG. 3, first, certifier algorithm P randomly generates vectors r₀, t₀εKⁿ and e₀εK^{m}. Next, certifier algorithm P calculates r₁←s−r₀. This calculation corresponds to an operation of masking secret key s by vector r₀. Further, certifier algorithm P calculates t₁←r₀−t₀. Next, certifier algorithm P calculates e₁←F(r₀)−e₀.

### Step #1 (Subsequence):

Next, certifier algorithm P calculates c₀←H(r₁,G(t₀,r₁)+e₀). Next, certifier algorithm P calculates c₁←H(t₀,e₀). Next, certifier algorithm P calculates c₂←H(t₁,e₁). Message (c₀,c₁,c₂) generated in step #1 is sent to verifier algorithm V.

### Step #2:

Verifier algorithm V having received message (c₀,c₁,c₂) selects which verification pattern is used among three verification patterns. For example, verifier algorithm V selects one numerical value from three numerical values {0, 1, 2} indicating the verification pattern types, and sets the selected numerical value as request Ch. This request Ch is sent to certifier algorithm P.

### Step #3:

Certifier algorithm P having received request Ch generates response Rsp sent to verifier algorithm V, according to received request Ch. In the case of Ch=0, certifier algorithm P generates response Rsp=(r₀,t₁,e₁). In the case of Ch=1, certifier algorithm P generates response Rsp=(r₁,t₀,e₀). In the case of Ch=2, certifier algorithm P generates response Rsp=(r₁,t₁,e₁). Response Rsp generated in step #3 is sent to verifier algorithm V.

### Step #4:

Verifier algorithm V having received response Rsp performs the following verification processing by the use of received response Rsp.

In the case of Ch=0, verifier algorithm V verifies whether the equal sign of c₁=H(r₀−t₁,F(r₀)−e₁) is established. Further, verifier algorithm V verifies whether the equal sign of c₂=H(t₁,e₁) is established. Verifier algorithm V outputs a value of 1 indicating the authentication success in a case where these verifications succeed, and outputs a value of 0 indicating the authentication failure in a case where there is a failure in the verifications.

In the case of Ch=1, verifier algorithm V verifies whether the equal sign of c₀=H(r₁,G(t₀,r₁)+e₀) is established. Further, verifier algorithm V verifies whether the equal sign of c₁=H(t₀,e₀) is established. Verifier algorithm V outputs a value of 1 indicating the authentication success in a case where these verifications succeed, and outputs a value of 0 indicating the authentication failure in a case where there is a failure in the verifications.

In the case of Ch=2, verifier algorithm V verifies whether the equal sign of c₀=H(r₁,y−F(r₁)−G(t₁,r₁)−e₁) is established. Further, verifier algorithm V verifies whether the equal sign of c₂=H(t₁,e₁) is satisfied. Verifier algorithm V outputs a value of 1 indicating the authentication success in a case where these verifications succeed, and outputs a value of 0 indicating the authentication failure in a case where there is a failure in the verifications.

A construction example of an efficient algorithm according to the 3-pass scheme has been described above.

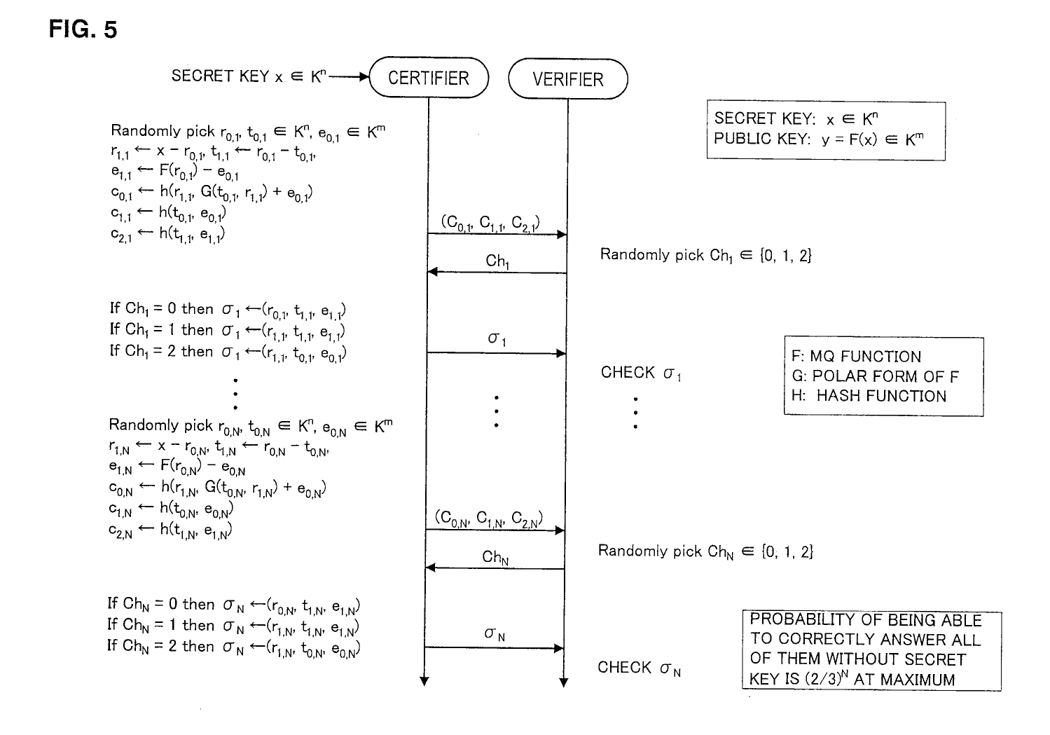

### 2-2: Construction Example of Serialization Algorithm (FIG. 5)

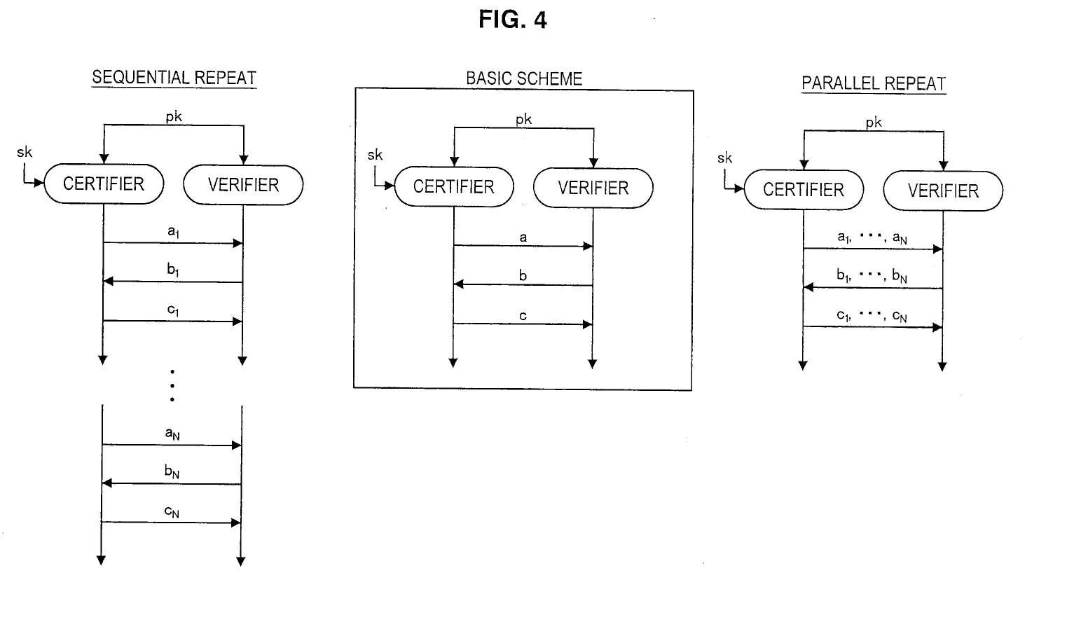

Next, with reference to FIG. 4 and FIG. 5, a method of parallelizing the 3-pass scheme algorithm illustrated in FIG. 3 is explained. Also, an explanation is omitted with respect to a construction of key generation algorithm Gen.

Here, if the above conversation protocol is applied, it is possible to suppress the probability of perjury success to ⅔ or less. Therefore, if this conversation protocol is executed twice, it is possible to suppress the probability of perjury success to (⅔)² or less. Further, if this conversation protocol is executed N times, the probability of perjury success becomes (⅔)^{N}, and, by setting N to a sufficiently high number (for example, N=140), the probability of perjury success becomes vanishingly small.

As a method of executing the conversation protocol multiple times, for example, as illustrated in FIG. 4, there are a sequential method (FIG. 4(A)) in which exchange of a message, request or response is sequentially repeated multiple times, and a parallel method (FIG. 4B) in which exchange of multiple messages, requests and responses is performed by one time. Further, there may be a hybrid-type method combining the sequential method and the parallel method. Also, FIG. 4(C) illustrates a scheme to execute the conversation protocol of FIG. 3 once. The sequential method illustrated in FIG. 4(A) repeats the conversation protocol of FIG. 4(C) multiple times. Here, with reference to FIG. 5, an algorithm to execute the above-mentioned conversation protocol related to the 3-pass scheme in a sequential manner (hereafter referred to as “serialization algorithm”) is explained in detail.

### Step #1, 1:

As illustrated in FIG. 5, first, certifier algorithm P randomly generates vectors r_{0,1}, t_{0,1}εKⁿ, and e_{0,1}εKm. Next, certifier algorithm P calculates r_{1,1}←s−r_{0,1}. This calculation corresponds to an operation of masking secret key s by vector r_{0,1}. Further, certifier algorithm P calculates t1,1←r0,1−t0,1. Next, certifier algorithm P calculates e_{1,1}←F(r0,1)−e_{0,1}.

### Step #1,1 (Subsequence):

Next, certifier algorithm P calculates c_{0,1}←H(r_{1,1},G(t_{0,1},r_{1,1})+e_{0,1}). Next, certifier algorithm P calculates c_{1,1}←H(t_{0,1},e_{0,1}). Next, certifier algorithm P calculates c_{2,1}←H(t_{1,1},e_{1,1}). Message (c_{0,1},c_{1,1},c_{2,1}) generated in step #1 is sent to verifier algorithm V.

### Step #2,1:

Verifier algorithm V having received message (c_{0,1},c_{1,1},c_{2,1}) selects which verification pattern is used among three verification patterns. For example, verifier algorithm V selects one numerical value from three numerical values {0, 1, 2} indicating the verification pattern types, and sets the selected numerical value as request Ch₁. This request Ch₁ is sent to certifier algorithm P.

### Step #3,1:

Certifier algorithm P having received request Ch₁ generates response Rsp to be sent to verifier algorithm V, according to received request Ch₁. In the case of Ch₁=0, certifier algorithm P generates response σ₁=(r_{0,1},t_{1,1},e_{1,1}). In the case of Ch₁=1, certifier algorithm P generates response σ₁=(r_{1,1},t_{0,1},e_{0,1}). In the case of Ch₁=2, certifier algorithm P generates response σ₁=(r_{1,1},t_{1,1},e_{1,1}). Response σ₁ generated in step #3 is sent to verifier algorithm V.

### Step #4,1:

Verifier algorithm V having received response σ₁ performs the following verification processing by the use of received response σ₁.

In the case of Ch₁=0, verifier algorithm V verifies whether the equal sign of c_{1,1}=H(r_{0,1}−t_{1,1},F(r_{0,1})−e_{1,1}) is established. Further, verifier algorithm V verifies whether the equal sign of c_{2,1}=H(t_{1,1},e_{1,1}) is established. Verifier algorithm V outputs a value of 1 indicating the authentication success in a case where these verifications succeed, and outputs a value of 0 indicating the authentication failure in a case where there is a failure in the verifications.

In the case of Ch₁=1, verifier algorithm V verifies whether the equal sign of c_{0,1}=H(r_{1,1},G(t_{0,1},r_{1,1})+e_{0,1}) is established. Further, verifier algorithm V verifies whether the equal sign of c_{1,1}=H(t_{0,1},e_{0,1}) is established. Verifier algorithm V outputs a value of 1 indicating the authentication success in a case where these verifications succeed, and outputs a value of 0 indicating the authentication failure in a case where there is a failure in the verifications.

In the case of Ch₁=2, verifier algorithm V verifies whether the equal sign of c_{0,1}=H(r_{1,1},y−F(r_{1,1})−G(t_{1,1},r_{1,1})−e_{1,1}) is established. Further, verifier algorithm V verifies whether the equal sign of c_{2,1}=H(t_{1,1},e_{1,1}) is established. Verifier algorithm V outputs a value of 1 indicating the authentication success in a case where these verifications succeed, and outputs a value of 0 indicating the authentication failure in a case where there is a failure in the verifications.

When steps 1,1 to 4,1 are finished, processing similar to steps 1,1 to 4,1 is performed N times. The N-th processing is as follows.

### Step #1,N:

As illustrated in FIG. 5, certifier algorithm P randomly generates vectors r_{0,N}, t_{0,N}εKⁿ and e_{0,N}εK^{m}. Next, certifier algorithm P calculates r_{1,N}←s−r_{0,N}. This calculation corresponds to an operation of masking secret key s by vector r_{0,N}. Further, certifier algorithm P calculates t_{1,N}←r_{0,N}−t_{0,N}. Next, certifier algorithm P calculates e_{1,N}←F(r_{0,N})−e_{0,N}.

### Step #1,N (Subsequence):

Next, certifier algorithm P calculates c_{0,N}←H(r_{1,N},G(t_{0,N},r_{1,N})+e_{0,N}). Next, certifier algorithm P calculates c_{1,N}←H(t_{0,N},e_{0,N}). Next, certifier algorithm P calculates c_{2,N}←H(t_{1,N},e_{1,N}). Message (c_{0,N},c_{1,N},c_{2,N}) generated in step #1 is sent to verifier algorithm V.

### Step #2,N:

Verifier algorithm V having received message (c_{0,N},c_{1,N},c_{2,N}) selects which verification pattern is used among three verification patterns. For example, verifier algorithm V selects one numerical value from three values {0, 1, 2} indicating the verification pattern types, and sets the selected numerical value as request Ch_{N}. This request Ch_{N} is sent to certifier algorithm P.

### Step #3,N:

Certifier algorithm P having received request Ch_{N} generates response σ_{N} to be sent to verifier algorithm V, according to received request Ch_{N}. In the case of Ch_{N}=0, certifier algorithm P generates response σ_{N}=(r_{0,N},t_{1,N},e_{1,N}). In the case of Ch_{N}=2, certifier algorithm P generates response σ_{N}=(r_{1,N},t_{0,N},e_{0,N}). In the case of Ch_{N}=2, certifier algorithm P generates response σ_{N}=(r_{1,N},t_{1,N},e_{1,N}). Response σ_{N} generated in step #3 is sent to verifier algorithm V.

### Step #4,N:

Verifier algorithm V having received response σ_{N} performs the following verification processing by the use of received response σ_{N}.

In the case of Ch₁=0, verifier algorithm V verifies whether the equal sign of c_{1,N}=H(r_{0,N}−t_{1,N},F(r_{0,N})−e_{1,N}) is established. Further, verifier algorithm V verifies whether the equal sign of c_{2,1}=H(t_{1,N},e_{1,N}) is established. Verifier algorithm V outputs a value of 1 indicating the authentication success in a case where these verifications succeed, and outputs a value of 0 indicating the authentication failure in a case where there is a failure in the verifications.

In the case of Ch_{N}=1, verifier algorithm V verifies whether the equal sign of c_{0,N}=H(r_{1,N},G(t_{0,N},r_{1,N})+e_{0,N}) is established. Further, verifier algorithm V verifies whether the equal sign of c_{1,N}=H(t_{0,N},e_{0,N}) is established. Verifier algorithm V outputs a value of 1 indicating the authentication success in a case where these verifications succeed, and outputs a value of 0 indicating the authentication failure in a case where there is a failure in the verifications.

In the case of Ch_{N}=2, verifier algorithm V verifies whether the equal sign of c_{0,N}=H(r_{1,N},y−F(r_{1,N})−G(t_{1,N},r_{1,N})−e_{1,N}) is established. Further, verifier algorithm V verifies whether the equal sign of c_{2,N}=H(t_{1,N},e_{1,N}) is established. Verifier algorithm V outputs a value of 1 indicating the authentication success in a case where these verifications succeed, and outputs a value of 0 indicating the authentication failure in a case where there is a failure in the verifications.

A construction example of an efficient serialization algorithm according to the 3-pass scheme has been described above.

### 3: CONSTRUCTION OF ALGORITHM ACCORDING TO 5-PASS PUBLIC KEY AUTHENTICATION SCHEME

Next, the algorithm according to the 5-pass public key authentication scheme is explained. Also, in the following explanations, the 5-pass public key authentication scheme may be referred to as “5-pass scheme.”

Although the perjury probability per once in the conversation protocol is ⅔ in the case of the 3-pass scheme, the perjury probability per once in the conversation protocol is ½+1/q in the case of the 5-pass scheme. However, q is an order of a used ring. Therefore, in a case where the order of the ring is sufficiently large, it is possible to reduce the perjury probability per once more in the 5-pass scheme, and it is possible to sufficiently reduce the perjury probability with a small number of executions of the conversation protocol.

For example, in a case where it is requested to adjust the perjury probability to ½ⁿ or less, it is requested to execute the conversation protocol in the 3-pass scheme n/(log 3−1)=1.701n times or more. Meanwhile, in a case where it is requested to adjust the perjury probability to ½ⁿ or less, it is requested to execute the conversation protocol in the 5-pass scheme n/(1−log(1+1/q)) times or more. Therefore, if q=24 is set, the communication traffic requested to realize the same security level is smaller in the 5-pass scheme than the 3-pass scheme.

### 3-1: Construction Example of Specific Algorithm (FIG. 6)

First, with reference to FIG. 6, a construction example of a specific algorithm according to the 5-pass scheme is introduced. FIG. 6 is an explanatory diagram to explain the construction of the specific algorithm according to the 5-pass scheme. Here, a case is considered where a combination of quadratic polynomials (f₁(x), . . . , fₘ(x)) is used as part of public key pk. However, it is assumed that quadratic polynomial fᵢ(x) is expressed as above Expression (6). Also, it is assumed that vector (x₁, . . . , xₙ) is written as “x” and the combination of quadratic polynomials (f₁(x), . . . , fₘ(x)) is written as “multivariable polynomial F(x).”

Similar to an algorithm according to the 3-pass scheme, multivariable polynomial F₁(x) used to mask multivariable polynomial F(x+r₀) by the use of two vector t₀εKⁿ and e₀εK^{m} is expressed as F₁(x)=G(x,t₀)+e₀. When this expression is used, the relation expressed by Expression (23) listed below is acquired with respect to multivariable polynomial F(x+r0).

$$\begin{matrix}{Ch}_{A} \cdot F ( x + {r}_{0} ) + {F}_{1} ( x ) = {Ch}_{A} \cdot F ( x ) + {Ch}_{A} \cdot F ( {r}_{0} ) + \\ {Ch}_{A} \cdot G ( x , {r}_{0} ) + G ( x , {t}_{0} ) + {e}_{0} \\ = {Ch}_{A} \cdot F ( x ) + G ( x , {Ch}_{A} \cdot {r}_{0} + {t}_{0} ) + \\ {Ch}_{A} \cdot F ( {r}_{0} ) + {e}_{0 }\end{matrix} \qquad ( 23 )$$

Therefore, if t₁=Ch_{A}·r₀+t₀ and e₁=Ch_{A}·F(r₀)+e₀ are set, masked multivariable polynomial F₂(x)=Ch_{A}·F(x+r₀)+F₁(x) can be expressed by two vectors t₁εKⁿ and e₁εK^{m}. In view of these reasons, if F₁(x)=G(x,t₀)+e₀ is set, it is possible to express F₁ and F₂ by the use of the vector on Kⁿ and the vector on K^{m}, and it is possible to realize an efficient algorithm in which the data size requested for the communication is small.

Also, all information on r₀ is not leaked from F₂ (or F₁). For example, even if e₁ and t₁ (or, e₀ and t₀) are given, it is not possible to know all information on r₀ as long as e₀ and t₀ (or e₁ and t₁) are not known. Therefore, the zero knowledge is assured. In the following, the algorithm of the 5-pass scheme constructed based on the above-mentioned logic is explained. The algorithm of the 5-pass scheme described herein includes key generation algorithms Gen, certifier algorithms P and verifier algorithms V as listed below.

### (Key Generation Algorithm Gen)

Key generation algorithm Gen generates multivariable polynomials f₁(x₁, . . . , xₙ), . . . , fₘ(x₁, . . . , xₙ) defined on ring K and vector s=(s₁, . . . , sₙ)εKⁿ. Next, key generation algorithm Gen calculates y=(y₁, . . . , yₘ)←(f₁(s), . . . , fₘ(s)). Subsequently, key generation algorithm Gen sets (f₁, . . . , fₘ,y) as public key pk and sets s as a secret key. In the following, vector (x₁, . . . , xₙ) is written as “x” and a combination of multivariable polynomials (f₁(x), . . . , fₘ(x)) is written as “F(x).”

### (Certifier Algorithm P and Verifier Algorithm V)

In the following, with reference to FIG. 6, processing executed by certifier algorithm P and verifier algorithm V in the conversation protocol is explained. In this conversation protocol, the certifier certifies to the verifier that “the certifier knows s satisfying y=F(s)” without leaking all information on secret key s to the verifier. Meanwhile, the verifier verifies whether the certifier knows “s” satisfying y=F(s). Here, it is assumed that public key pk is published to the verifier. Also, it is assumed that secret key s is secretly managed by the certifier. In the following, an explanation is given along the flowchart illustrated in FIG. 6.

### Step #1:

As illustrated in FIG. 6, first, certifier algorithm P randomly generates vectors r₀εKⁿ, t₀εKⁿ and e₀εK^{m}. Next, certifier algorithm P calculates r₁←s−r₀. This calculation corresponds to an operation of masking secret key s by vector r₀. Next, certifier algorithm P generates hash value c₀ of vectors r₀, t₀ and e₀. That is, certifier algorithm P calculates c₀←H(r₀,t₀,e₀). Next, certifier algorithm P generates hash value c₁ of G(t₀,r₁)+e₀ and r₁. That is, certifier algorithm P calculates c₁←H(r₁,G(t₀,r₁)+e₀). Message (c0,c1) generated in step #1 is sent to verifier algorithm V.

### Step #2:

Verifier algorithm V having received message (c0,c1) randomly selects one number Ch_{A} from q kinds of rings K and sends selected number Ch_{A} to certifier algorithm P.

### Step #3:

Certifier algorithm P having received number Ch_{A} calculates t₁←Ch_{A}·r₀−t₀. Further, certifier algorithm P calculates e₁←Ch_{A}·F(r₀)−e₀. Subsequently, certifier algorithm P sends t₁ and e₁ to verifier algorithm V.

### Step #4:

Verifier algorithm V having received t₁ and e₁ selects which verification pattern is used among two verification patterns. For example, verifier algorithm V selects one numerical value from two numerical values {0, 1} indicating the verification pattern types, and sets the selected numerical value as request Ch_{B}. This request Ch_{B} is sent to certifier algorithm P.

### Step #5:

Certifier algorithm P having received request Ch_{B} generates response Rsp to be sent back to verifier algorithm V, according to received request Ch_{B}. In the case of Ch_{B}=0, certifier algorithm P generates response Rsp=r₀. In the case of Ch_{B}=1,certifier algorithm P generates response Rsp=r₁. Response Rsp generated in step #5 is sent to verifier algorithm V.

### Step #6:

Verifier algorithm V having received response Rsp performs the following verification processing by the use of received response Rsp.

In the case of Ch_{B}=0, verifier algorithm V executes r₀←Rsp. Subsequently, verifier algorithm V verifies whether the equal sign of c₀=H(r₀,Ch_{A}·r₀−t₁,Ch_{A}·F(r₀)−e₁) is established. Verifier algorithm V outputs a value of 1 indicating the authentication success in a case where this verification succeeds, and outputs a value of 0 indicating the authentication failure in a case where there is a failure in the verification.

In the case of Ch_{B}=1, verifier algorithm V executes r₁←Rsp. Subsequently, verifier algorithm V verifies whether the equal sign of c₁=H₁(r₁,Ch_{A}·(y−F(r₁))−G(t₁,r₁)−e₁) is established. Verifier algorithm V outputs a value of 1 indicating the authentication success in a case where this verification succeeds, and outputs a value of 0 indicating the authentication failure in a case where there is a failure in the verification.

A construction example of an efficient algorithm according to the 5-pass scheme has been described above.

### 3-2: Construction Example of Serialization Algorithm

The method of serializing the algorithm of the 5-pass scheme illustrated in FIG. 6 can be realized by executing the algorithm of the 5-pass scheme illustrated in FIG. 6 N times, in the same way as the serialization of the algorithm of the 3-pass scheme illustrated in FIG. 5.

### 4. CONFIGURATION EXAMPLE OF SYSTEM

### 4-1: Outline of System According to the Present Embodiment

First, with reference to FIG. 7, the outline of a system according to the present embodiment is explained. In the present embodiment, authentication levels are hierarchized in a case where authentication is performed using the above public key authentication.

FIG. 7 is a schematic diagram to explain load distribution by hierarchization of authentication levels according to the present embodiment. FIG. 7 typically illustrates a state where the user accesses a server 200 from a client terminal 100 through a network. When logging in the server 200 from the client terminal 100, the user performs user authentication. The server 200 is a server to manage, for example, a portal site or a social media network.

FIG. 7(A) illustrates a system in a case where user authentication is performed only once when the user accesses the server 200. In the system illustrated in FIG. 7(A), the user can enjoy all services provided by the server 200 only by performing authentication one time. That is, by performing the authentication one time from the client terminal 100, the user can perform all processing such as browsing of member pages, enjoying of general services, browsing of my pages of one's own, settlement by the use of one's own credit card and change in one's own user information.

However, in the system illustrated in FIG. 7(A), it is assumed that the load of the server 200 increases when the user logs in. Especially, when many users log in at the same timing, the load of the server increases. Also, in user authentication using secret codes, although it is possible to ensure the high security, comparatively long time is taken for the authentication processing. Accordingly, in individual users, it is considered that the login speed decreases and the wait time becomes long.

Meanwhile, if a method such as omitting a password input in a predetermined case is adopted like Japanese Patent Laid-Open No. 2002-278930 to reduce the load of the server 200, others other than the identical person can login and the decrease in security is assumed (i.e., problem of so-called “impersonation”).

Therefore, in the present embodiment, by distributing authentication processing even at the time of processing requests other than a login request of the user, load reduction of the server 200 is performed. FIG. 7(B) is a schematic diagram indicating load distribution by hierarchization of authentication levels according to the present embodiment. The present embodiment uses the above sequential method in which exchange of a message, request or response is sequentially repeated multiple times at the time of user authentication, and the multiple times of repetition are distributed every hierarchy of access to the server 200.

As an example, in the system illustrated in FIG. 7(A), it is assumed that, in the authentication processing performed only once at the time of user authentication, the authentication processing is performed with the repeat count of 140 times (N=140) by the above sequential method.

By contrast with this, in the method according to the present embodiment illustrated in FIG. 7(B), as an example, authentication processing by ten times of repetition processing is performed at the time of user authentication. By this authentication processing, the user can browse member pages and use general services for members, and so on. Here, browsing of public information can be used without performing the authentication processing. After that, when the user performs a predetermined operation to browse personal information (my page), the server 200 performs authentication processing by the repeat count of 40 times in total added up after the user authentication. Accordingly, the user can browse personal information.

Further, when the user performs a predetermined operation to change the personal information, the server 200 performs authentication processing by the repeat count of 100 times in total added up after the user authentication. Accordingly, the user can change the personal information (such as the password change and the change in the address and the telephone number).

After that, when the user performs a predetermined operation for credit card transactions, the server 200 performs authentication processing by the repeat count of 140 times in total added up after the user authentication. Accordingly, the user can perform credit-card transactions.

As described above, in the present embodiment, by distributing authentication processing even at the time of processing requests other than login requests, it is possible to achieve load reduction of the server 200. Accordingly, by distributing the number of authentication of many users, it is possible to distribute the load on the side of the 200 server. Also, since the authentication processing is smoothly performed, the user can perform an operation such as authentication processing while feeling a so-called “smooth sense” without feeling the time of the authentication processing. Also, on the side to build a site of the server 200, by recognizing the repeat count at the time of building the site, it is possible to recognize the degree of importance of requested processing.

Thus, in the present embodiment, it is possible to adjust the authentication level by the setting of repeat count N. Also, since the repeat count has no relation with the strength of a secret key, it is possible to perform processing without decreasing the strength of the secret key. Further, it is possible to set the authentication level according to the degree of importance of requested processing. Moreover, by cumulating the authentication count according to the hierarchy, it is possible to enhance the authentication strength.

### 4-2: Configuration Example of System

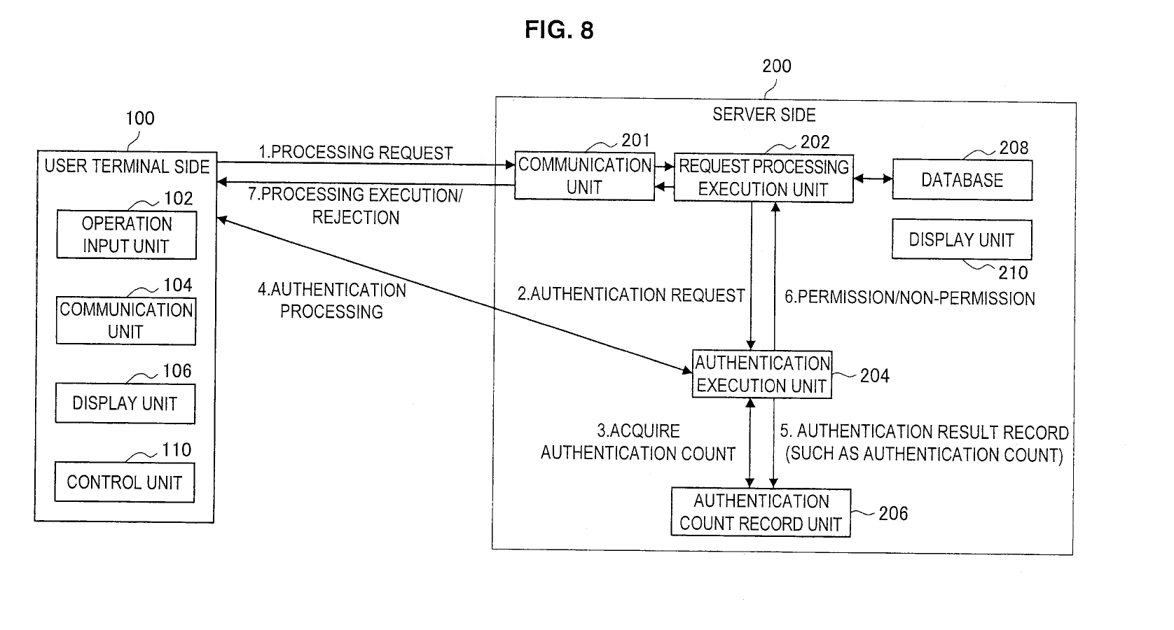

FIG. 8 is a schematic diagram indicating a configuration example of a system according to the present embodiment. As illustrated in FIG. 8, the client terminal 100 and the server 200 are connected through a network 300 such as the Internet. The client terminal 100 includes an operation input unit 102, a communication unit 104, a display panel 106 and a control unit 110. The operation input unit 102 is a component such as a mouse, a keyboard, a touch pad and a touch sensor. The communication unit 104 transmits a processing request to the server 200 or receives information on a processing request from the server 200, through the network 300. The display panel 106 includes a liquid crystal display panel (LCD). The touch sensor of the above operation input unit 102 may form a touch panel provided on a display screen of the display panel 106. The control unit 110 includes a central processing unit such as a CPU, and controls the entire of the client terminal 100. The client terminal 100 illustrated in FIG. 8 can include components such as a circuit (hardware) or a central processing unit like a CPU and a program (software) to operate this.

The server 200 includes a communication unit 201, a request processing execution processing 202, an authentication execution unit 204, an authentication count record unit 206, a database 208 and a display panel 210. The communication unit 201 performs communication with the client terminal 100 through the network 300, receives a processing request sent from the client terminal 100 and transmits a response with respect to the processing request. The request processing execution processing 202 executes processing according to a processing request transmitted from the client terminal 100. In a case where a processing request of user authentication is sent from the client terminal 100, the processing request execution unit 202 acquires this processing request, requests the user authentication to the authentication execution unit 204 and receives information on permission/non-permission of authentication from the authentication execution unit 204. Also, when a processing request to browse specific information is given from the client terminal 100, the request processing execution processing 202 extracts information corresponding to the processing request from the database 208 and transmits it to the client terminal 100 through the communication unit 201.

The authentication execution unit 204 executes user authentication by the above public key authentication scheme. The authentication execution unit 204 performs authentication processing by distributing multiple times of repetition per hierarchy of access to the server 200, using the above sequential method in which exchange of a message, request or response is sequentially repeated multiple times at the time of user authentication. In the example illustrated in FIG. 7(B), in a case where a processing request of user authentication is sent from the client terminal 100, the authentication execution unit 204 performs authentication processing by the repeat count of ten times. After that, for example, in a case where a processing request of browsing a my page is sent from the client terminal 100, the authentication execution unit 204 performs authentication processing by the repeat count of 40 times in total added up after the user authentication.

The authentication count record unit 206 records the repeat count of authentication. Especially, the authentication count record unit 206 can record the repeat count of authentication added up after the user authentication. The database 208 stores data related to a service chiefly provided by the server 200. For example, in a case where the server 200 is a social network server, the database 208 stores information on the information of each user registered in the social network. Also, in a case where the server 200 is a portal server to provide a portal site, the database 208 stores information on the portal site.

Also, the components of the server 200 illustrated in FIG. 8 can include a circuit (hardware) or a central processing unit like a CPU and a program (software) to operate this.

### 4-3: Operation of System

In the configuration illustrated in FIG. 8, when the operation input unit 102 of the client terminal 100 is operated by the user, the control unit 110 transmits a processing request of user authentication from the communication unit 104 to the server 200. The request processing execution processing 202 of the server 200 receives the processing request sent from the client terminal 100 through the communication unit 201. The request processing execution processing 202 determines whether the processing request transmitted from the client terminal 100 is to be authenticated, and, in a case where it is to be authenticated, the authentication execution unit 204 is requested to execute authentication. Here, the processing request to be authenticated corresponds to a request of login, a request to jump to a my page, a change request of user information and a request of credit card transactions, and so on. Also, a request not to be authenticated corresponds to a request to simply browse information in each hierarchy, and so on. In a case where the processing request is not to be authenticated, the request processing execution unit 202 transmits information extracted from the database 208 according to the processing request, to the client terminal 100.

The authentication execution unit 204 acquires the number of authentication to jump to a hierarchy corresponding to a user's processing request, on the basis of the number of authentication recorded in the authentication count record unit 206. Subsequently, the authentication execution unit 204 executes authentication of the acquired authentication count. When the authentication is terminated, the authentication execution unit 204 records the number of authentication newly performed, in the authentication count record unit 206. Accordingly, the authentication count record unit 206 records the total number of authentication performed after the user logs in.

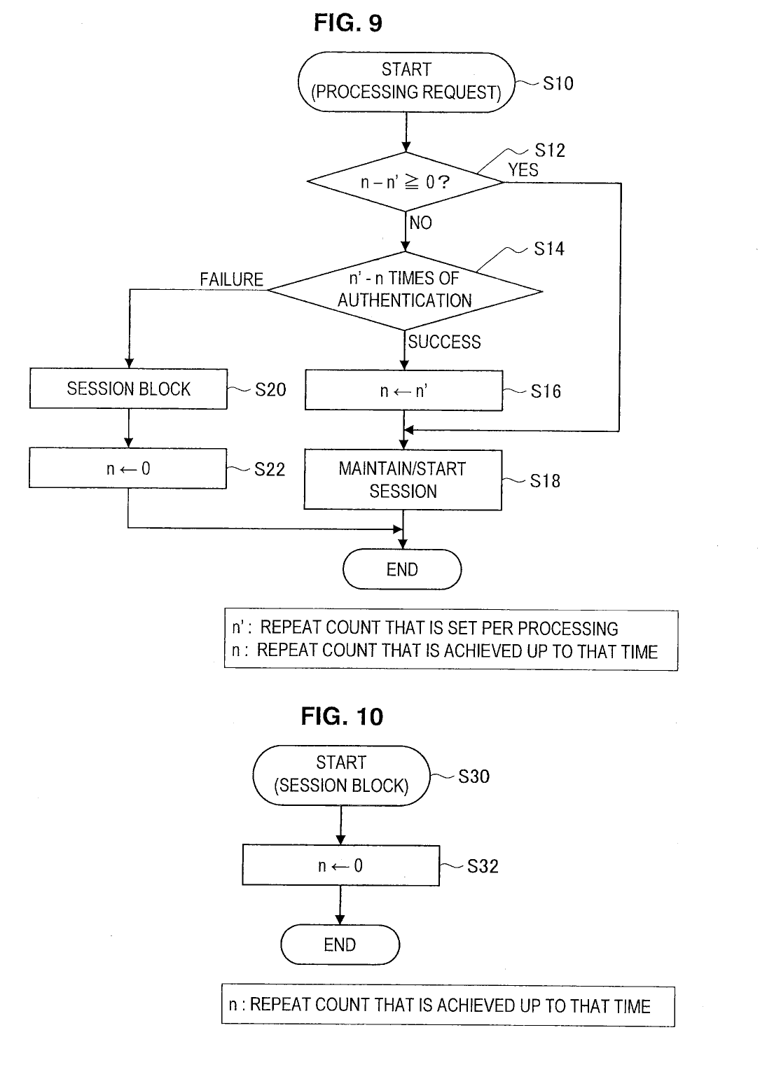

FIG. 9 is a flowchart indicating processing in the server 200. FIG. 9 illustrates processing chiefly performed by the authentication execution unit 204 of the server 200. First, in step S10, the client terminal 100 performs a processing request. Here, it is assumed that a processing request to be authenticated is performed. In next step S12, in a case where the repeat count of authentication achieved up to now is assumed to be n and the repeat count that is set every processing depending on a processing request from the client terminal 100 is assumed to be n′, it is determined whether n−n′≧0 is established. Here, the repeat count n of authentication achieved up to now is recorded in the authentication count record unit 206. When the user logs in the server 200 for the first time after logging off the server 200, since authentication is not executed in the interim, n=0 is established.

In the case of the example illustrated in FIG. 7(B), the repeat count n′ set every processing is 10 times at the time of user authentication, 40 times for browsing of personal information. 100 times for a change in personal information and 140 times for credit card transactions.

In the case of n−n′≧0 in step S12, it proceeds to step S18. In a case where it proceeds to step S18, since the repeat count n of authentication up to now is larger than the repeat count n′ corresponding to the processing request from the client terminal 100, the repeat count n′ corresponding to the processing request is already achieved. Therefore, a session is maintained/started in step S18.

Meanwhile, in the case of n−n′<0 in step S12, it proceeds to step S14. In a case where it proceeds to step S14, since the repeat count n′ corresponding to the processing request from the client terminal 100 is larger than the repeat count n of authentication up to now, the repeat count of authentication up to now is insufficient. Therefore, in step S14, the shortfall of the repeat count of authentication is calculated by calculating n′−n and n′−n times of authentication are executed.

When n′−n times of authentication succeed in step S14, it proceeds to step S16 and the repeat count n of authentication achieved up to now is replaced with the value of n′ corresponding to the processing request received in step S10 (n←n′) and recorded in the authentication count record unit 206.

In next step S18, since the authentication succeeds in step S14, the session corresponding to the processing request is maintained or the session is started.

Meanwhile, in a case where n′−n times of authentication fails in step S14, it proceeds to step S20. The failure of authentication is caused due to a case where there is a mistake in user's authentication information (in the case of so-called “impersonation by others”) or a communication environment degrades. In this case, the session is interrupted in step S20 and the repeat count n achieved up to now is reset to 0 in step S22 (n←0). Accordingly, in a case where the user performs a processing request next, authentication is executed from the beginning. After steps S18 and S22, the processing is terminated (i.e. end).

FIG. 10 is a flowchart indicating processing at the time when a session is blocked by a request from the client terminal 100. When a session block processing request is transmitted from the client terminal 100, the session is blocked in step S30. Subsequently, in next step S32, the repeat count n achieved up to now is reset to 0 (n←0). Accordingly, when the user performs a processing request next, authentication is performed from the beginning. After step S32, processing is terminated (i.e. end).

### 4-4: Regarding User Authentication Protocol

In the present embodiment, as described above, a scheme of user authentication has been described above using, as an example, the public key authentication scheme providing security grounds by the hardness of a solving problem with respect to multidimensional multivariable simultaneous equations. The user authentication protocol is not limited to this, and other protocols are widely available as long as they are authentication protocols that can adopt the sequential configuration as illustrated in FIG. 5. Here, as described above, the authentication protocol is an encryption technique to certify that secret key s corresponding to public key v is held, without revealing secret key s. Therefore, by registering public key v in the server 200 beforehand, the server 200 can use it at the time of user authentication. In such an authentication protocol, it is possible to change the strength of authentication by setting the repeat count. Also, the communication amount becomes smaller when the repeat count is less. Further, the setting of the repeat count has no relation with the strength of secret key s.

Especially, since an MQ protocol provides high security, is able to adopt a sequential configuration and provides the repeat count having no relation with the strength of the secret key, it can be suitably used for authentication processing according to the present embodiment.

As other authentication protocols, for example, an authentication protocol based on the syndrome decoding problem can be used (a new paradigm for public key identification, CRYPTO 1993, IEEE Trans. on IT 1996).

### 4-5: Regarding Authentication Repeat Count n′

The authentication count n′ to be passed per processing can be arbitrarily set by the site designer on the side of the server 200. Here, it is preferable to set authentication count n′ according to the following policies.

The repeat count is increased in processing with a lot of prior procedures.

For example, a general SNS sets the repeat count n′ to be larger in order of “browsing of public information<login<browsing of member information<browsing of personal information<personal information change<transaction operation” (see FIG. 7(B)).

When the perjury probability by one repeat count is ⅔, regarding processing with the largest number, it is desirable to set it to 140 times recommended in a code theory.

### 4-6: Regarding Example of Changing Authentication Level Every User

In the above example, although same authentication repeat count n′ is set to each user, it is possible to recognize the user ID on the server side and set a different authentication level value (authentication count n′) every user ID.

Accordingly, it is possible to vary the weighting by the setting of authentication levels, between the user who is certainly to be authenticated in view of the side of the server 200 (i.e., site side) and the user who is less likely to be authenticated. For example, in a case where it is known that a certain user is a celebrity, authentication count n′ is uniformly set higher than general users. For example, in FIG. 7(B), authentication count n′ per hierarchy is changed and set higher, for example, from 10 to 20, from 40 to 50, from 100 to 110 or from 140 to 150, and so on. Accordingly, when the user is a celebrity, it is possible to suppress “impersonation” by others at higher accuracy.

### 5: CONFIGURATION EXAMPLE OF HARDWARE (FIG. 11)

Each above algorithm can be executed using a hardware configuration of an information processing apparatus illustrated in FIG. 11, for example. That is, the processing in each algorithm is realized by controlling hardware illustrated in FIG. 11 using a computer program. Here, this hardware form is arbitrary, and, for example, includes portable information terminals such as a personal computer, mobile phone, PHS and PDA, a game machine, a contact/non-contact IC chip and various kinds of information appliances. However, the above PHS is abbreviation of Personal Handy-phone System. Also, the above PDA is abbreviation of Personal Digital Assistant

As illustrated in FIG. 11, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removable recording medium 928. The ROM 904 is a mechanism for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removable recording medium 928 such as a magnetic disk, an optical disk, a magneto-optical disk, or a semiconductor memory, or writes information in the removable recording medium 928. The removable recording medium 928 is, for example, a DVD medium, a Blu-ray medium, an HD-DVD medium, various types of semiconductor storage media, or the like. Of course, the removable recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a device for contact or non-contact communication, or the like. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

The technical content described above is applicable to various kinds of information processing apparatuses such as a PC, a mobile phone, a game machine, an information terminal, information appliances and a car navigation system. Here, functions of an information processing apparatus described below can be realized using one information processing apparatus or realized using a plurality of information processing apparatuses. Also, a data storage unit and computation processing unit used at the time of performing processing by an information processing apparatus described below may be installed in the information processing apparatus or may be installed in a device connected through a network.

As described above, according to the present embodiment, by distributing authentication processing even at processing requests other than a login request of the user, it is possible to reduce the load of the server 200. Therefore, since the authentication processing is smoothly performed, the user can perform an operation such as authentication processing in a comfortable manner without feeling the time of the authentication processing.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a processing request acquisition unit configured to sequentially acquire a plurality of processing requests from a user; and

an authentication execution unit configured to distribute and execute user authentication processing according to a timing of acquiring the plurality of processing requests.

(2) The information processing apparatus according to (1), wherein the authentication execution unit sets a number of times of the user authentication processing according to an authentication level of each of the plurality of processing requests and executes the user authentication processing.
(3) The information processing apparatus according to (1), wherein the authentication execution unit executes the user authentication processing using an authentication protocol that repeats an exchange of information for the user authentication processing a plurality of times.
(4) The information processing apparatus according to (3), wherein the authentication execution unit executes user authentication processing by an MQ protocol.
(5) The information processing apparatus according to (3), further including an authentication count record unit configured to record a repeat count n of the user authentication processing executed,

wherein the authentication execution unit further executes the user authentication processing in a case where the repeat count n does not reach a repeat count n′ set in advance depending on a type of the processing request.

(6) The information processing apparatus according to (5), wherein the authentication execution unit executes the user authentication processing until the repeat count n reaches the repeat count n′ set in advance depending on the type of the processing request.
(7) The information processing apparatus according to (5), wherein the authentication execution unit further executes the user authentication processing (n′−n) times in a case where the repeat count n does not reach the repeat count n′ set in advance depending on the type of the processing request.
(8) The information processing apparatus according to (5), wherein the repeat count n′ set in advance is set to be a higher value as confidentiality of a processing request of a user is higher.
(9) The information processing apparatus according to (5), wherein the repeat count n′ set in advance is set to be a different value for each user.
(10) The information processing apparatus according to (5), wherein the authentication execution unit resets the repeat count n of the user authentication processing executed to 0 in a case where the user authentication processing is not normally executed.
(11) An information processing system including:

a client terminal configured to transmit a processing request input from a user; and

a server including a processing request acquisition unit configured to sequentially acquire a plurality of the processing requests from the client terminal, and an authentication execution unit configured to distribute and execute user authentication processing according to a timing of acquiring the plurality of the processing requests.

(12) An information processing method including:

sequentially acquiring a plurality of processing requests from a user; and

distributing and executing user authentication processing according to a timing of acquiring the plurality of processing requests.

(13) A program that causes a computer to function as:

a device configured to sequentially acquire plurality of processing requests from a user; and

a device configured to distribute and execute user authentication processing according to a timing of acquiring the plurality of processing requests.

(14) A client terminal including:

a transmission unit configured to transmit a processing request input from a user; and

a reception unit configured to receive a result of user authentication processing from a server that sequentially acquires a plurality of the processing requests from the client terminal and distributes and executes the user authentication processing according to a timing of acquiring the plurality of the processing requests.

The present disclosure contains subject matter related to that disclosed in Japanese Priority Patent Application JP 2012-193891 filed in the Japan Patent Office on Sep. 4, 2012, the entire content of which is hereby incorporated by reference.

What is claimed is:

1. An information processing apparatus comprising:
a processing request acquisition unit configured to sequentially acquire a plurality of processing requests from a user; and
an authentication execution unit configured to distribute and execute user authentication processing according to a timing of acquiring the plurality of processing requests.

2. The information processing apparatus according to claim 1, wherein the authentication execution unit sets a number of times of the user authentication processing according to an authentication level of each of the plurality of processing requests and executes the user authentication processing.

3. The information processing apparatus according to claim 1, wherein the authentication execution unit executes the user authentication processing using an authentication protocol that repeats an exchange of information for the user authentication processing a plurality of times.

4. The information processing apparatus according to claim 3, wherein the authentication execution unit executes user authentication processing by an MQ protocol.

5. The information processing apparatus according to claim 3, further comprising an authentication count record unit configured to record a repeat count n of the user authentication processing executed,
wherein the authentication execution unit further executes the user authentication processing in a case where the repeat count n does not reach a repeat count n′ set in advance depending on a type of the processing request.

6. The information processing apparatus according to claim 5, wherein the authentication execution unit executes the user authentication processing until the repeat count n reaches the repeat count n′ set in advance depending on the type of the processing request.

7. The information processing apparatus according to claim 5, wherein the authentication execution unit further executes the user authentication processing (n′−n) times in a case where the repeat count n does not reach the repeat count n′ set in advance depending on the type of the processing request.

8. The information processing apparatus according to claim 5, wherein the repeat count n′ set in advance is set to be a higher value as confidentiality of a processing request of a user is higher.

9. The information processing apparatus according to claim 5, wherein the repeat count n′ set in advance is set to be a different value for each user.

10. The information processing apparatus according to claim 5, wherein the authentication execution unit resets the repeat count n of the user authentication processing executed to 0 in a case where the user authentication processing is not normally executed.

11. An information processing system comprising:
a client terminal configured to transmit a processing request input from a user; and
a server including a processing request acquisition unit configured to sequentially acquire a plurality of the processing requests from the client terminal, and an authentication execution unit configured to distribute and execute user authentication processing according to a timing of acquiring the plurality of the processing requests.

12. An information processing method comprising:
sequentially acquiring a plurality of processing requests from a user; and
distributing and executing user authentication processing according to a timing of acquiring the plurality of processing requests.

13. A program that causes a computer to function as:
a device configured to sequentially acquire a plurality of processing requests from a user; and
a device configured to distribute and execute user authentication processing according to a timing of acquiring the plurality of processing requests.

14. A client terminal comprising:
a transmission unit configured to transmit a processing request input from a user; and
a reception unit configured to receive a result of user authentication processing from a server that sequentially acquires a plurality of the processing requests from the client terminal and distributes and executes the user authentication processing according to a timing of acquiring the plurality of the processing requests.
